(19) United States
(12) Patent Application Publication
(10) Pub. No.: US 2016/0005551 A1
(43) Pub. Date: Jan. 7, 2016

(54) COMPOSITE PARTICLES FOR ELECTROCHEMICAL DEVICE ELECTRODE, METHOD FOR MANUFACTURING COMPOSITE PARTICLES FOR ELECTROCHEMICAL DEVICE ELECTRODE, ELECTROCHEMICAL DEVICE ELECTRODE, AND ELECTROCHEMICAL DEVICE

(71) Applicant: ZEON CORPORATION, Tokyo (JP)

(72) Inventor: Takuya ISHII, Tokyo (JP)

(73) Assignee: ZEON CORPORATION, Tokyo (JP)

(21) Appl. No.: 14/770,383

(22) PCT Filed: Feb. 27, 2014
(86) PCT No.: PCT/JP2014/054835

§ 371 Date: Aug. 25, 2015

(30) Foreign Application Priority Data
Feb. 27, 2013 (JP) 2013-037726

(51) Int. Cl. H01G 11/50; H01M 10/0525; H01G 11/28; H01M 4/62; H01G 11/86; H01G 11/06

(52) U.S. Cl. CPC H01G 11/50; H01G 11/86; H01G 11/06; H01G 11/28; H01M 4/622; H01M 10/0525

(57) ABSTRACT

A negative electrode active material, a binder resin, a water-soluble polymer, and water-insoluble polysaccharide polymer fibers are included.

### TECHNICAL FIELD

The present invention relates to composite particles for an electrochemical device electrode, and methods for manufacturing the composite particles for an electrochemical device electrode, an electrochemical device electrode, and an electrochemical device.

### BACKGROUND ART

An electrochemical device such as a lithium ion secondary battery, an electric double layer capacitor, or a lithium ion capacitor, which is compact and lightweight, has high energy density, and is further capable of repeatedly charging and discharging, has rapidly expanded the demand by utilizing the characteristics. The lithium ion secondary battery is used in a mobile field such as a mobile phone or a notebook personal computer, as it has a relatively high energy density. Meanwhile, the electric double layer capacitor is used as a small memory backup power supply for a personal computer or the like, as it can be charged and discharged rapidly. In addition, the electric double layer capacitor is expected to be applied as an auxiliary power supply for an electric vehicle or the like. Furthermore, the lithium ion capacitor taking advantages of the lithium ion secondary battery and the electric double layer capacitor is considered for applying to a use to which the electric double layer capacitor is applied and a use the specifications of which the electric double layer capacitor cannot satisfy, as it has a higher energy density and a higher output density than the electric double layer capacitor. Among these electrochemical devices, particularly in the lithium ion secondary battery, not only an application thereof to an in-vehicle use for a hybrid electric vehicle, an electric vehicle, or the like but also an application thereof to a power storage use has been considered recently.

An expectation for these electrochemical devices is high. Meanwhile, further improvement in the electrochemical devices, such as lowering resistance, increasing capacity, or improving mechanical characteristics and productivity is desired with expansion and development of the uses. In these circumstances, a more productive method for manufacturing an electrode for an electrochemical device is desired. Various improvements have been performed to a manufacturing method capable of high-speed molding and a material for the electrode for an electrochemical device suitable for the manufacturing method.

The electrode for an electrochemical device is generally obtained by laminating an electrode active material layer, which is formed by binding an electrode active material and an electroconductive auxiliary agent used if necessary with a binder resin, on a current collector. Examples of the electrode for an electrochemical device include an applied electrode which is manufactured by applying a slurry for an applied electrode including an electrode active material, a binder resin, an electroconductive auxiliary agent, and the like on a current collector and removing a solvent with heat or the like. However, it is difficult to manufacture a uniform electrochemical device due to migration of the binder resin or the like. In addition, this method costs high, and makes a working environment worse. Furthermore, a manufacturing equipment tends to be large with the method.

On the other hand, a method for obtaining an electrochemical device including a uniform electrode active material layer by obtaining composite particles and powder-molding thereof is proposed. As a method for manufacturing such an electrode active material layer, for example, Patent Literature 1 discloses a method for forming an electrode active material layer by spraying and drying a slurry for composite particles including an electrode active material, a binder resin, and a dispersion medium to obtain composite particles, and then forming an electrode active material layer using these composite particles. Such composite particles have low strength and may be broken during transportation such as pneumatic transportation. When an electrode active material layer is formed using broken composite particles, it is not possible to form a uniform electrode active material layer because fluidity of the powder is deteriorated by losing uniformity of a particle diameter of the composite particles. In addition, adhesion between the composite particles and adhesion between the electrode active material layer and the current collector become weak, so that cycle characteristics of a resulting electrochemical device are not sufficient.

Furthermore, in Patent Literature 1, although external additive particles are obtained, in which surfaces of the composite particles are coated with a fibrous electroconductive auxiliary agent, it is not possible to improve strength of the composite particles.

Also, Patent Literature 2 discloses that a slurry for an applied electrode which is applied to an electrode to form an electrode layer includes carbon fibers in order to enhance adhesion in the applied electrode. However, Patent Literature 2 discloses a method for manufacturing the applied electrode, different from powder-molding using composite particles, so that Patent Literature 2 does not disclose improving strength of the composite particles.

### CITATION LIST

### Patent Literature

Patent Literature 1: WO 2009/44856

Patent Literature 2: JP 2009-295666 A

### SUMMARY OF INVENTION

### Technical Problem

An object of the present invention is to provide composite particles for an electrochemical device electrode and a method for manufacturing the composite particles for an electrochemical device electrode having sufficient strength and capable of obtaining sufficient adhesion in forming an electrode, and further to provide an electrochemical device electrode and an electrochemical device using the composite particles for an electrochemical device electrode.

### Solution to Problem

As a result of intensive studies to solve the above-described problems, the present inventor has found that the above-described object can be achieved by obtaining composite particles using a water-soluble polymer and a water-insoluble polysaccharide polymer together, and has accomplished the present invention.

That is, the present invention provides:
(1) composite particles for an electrochemical device electrode, including a negative electrode active material, a binder resin, a water-soluble polymer, and water-insoluble polysaccharide polymer fibers;
(2) the composite particles for an electrochemical device electrode according to (1), the water-insoluble polysaccharide polymer having a fiber diameter of 5 to 3000 nm;
(3) the composite particles for an electrochemical device electrode according to (1) or (2), 100 parts by weight of the composite particles for an electrochemical device including 0.2 to 4 parts by weight of the water-insoluble polysaccharide polymer fibers;
(4) the composite particles for an electrochemical device electrode according to any one of (1) to (3), the binder resin being particulate;
(5) a method for manufacturing composite particles for an electrochemical device electrode to obtain the composite particles for an electrochemical device electrode according to any one of (1) to (4), including a step of obtaining a slurry for composite particles by dispersing the negative electrode active material, the binder resin, the water-soluble polymer, and the water-insoluble polysaccharide polymer fibers in a solvent, and a step of granulating by spray drying the slurry for composite particles;
(6) an electrochemical device electrode obtained by laminating an electrode active material layer including the composite particles for an electrochemical device electrode according to any one of (1) to (4) on a current collector;
(7) the electrochemical device electrode according to (6), the electrode active material layer being obtained by pressure-molding an electrode material including the composite particles for an electrochemical device electrode on the current collector; and
(8) an electrochemical device including the electrochemical device electrode according to (6) or (7).

### Advantageous Effects of Invention

The present invention can provide composite particles for an electrochemical device electrode and a method for manufacturing the composite particles for an electrochemical device electrode having sufficient strength and capable of obtaining sufficient adhesion in forming an electrode. In addition, the present invention can provide an electrochemical device electrode and an electrochemical device using the composite particles for an electrochemical device electrode.

### DESCRIPTION OF EMBODIMENTS

Hereinafter, composite particles for an electrochemical device electrode according to an embodiment of the present invention will be described. The composite particles for an electrochemical device electrode of the present invention (hereinafter, sometimes referred to as “composite particles”) include a negative electrode active material, a binder resin, a water-soluble polymer, and water-insoluble polysaccharide polymer fibers.

Note that, hereinafter, “positive electrode active material” means an electrode active material for a positive electrode, and “negative electrode active material” means an electrode active material for a negative electrode. In addition, “positive electrode active material layer” means an electrode active material layer provided in a positive electrode, and “negative electrode active material layer” means an electrode active material layer provided in a negative electrode.

(Negative Electrode Active Material)

Examples of the negative electrode active material used in the present invention include a material capable of electron delivery in a negative electrode of an electrochemical device. As the negative electrode active material when the electrochemical device is a lithium ion secondary battery, it is generally possible to use a substance which can occlude and release lithium.

Examples of the negative electrode active material preferably used for the lithium ion secondary battery include a negative electrode active material formed of carbon. Examples of the negative electrode active material formed of carbon include natural graphite, artificial graphite, and carbon black. Among them, graphite such as artificial graphite or natural graphite is preferable, and natural graphite is particularly preferable.

Further, other examples of the negative electrode active material preferably used for the lithium ion secondary battery include a negative electrode active material containing a metal. Particularly, a negative electrode active material containing at least one kind selected from a group consisting of tin, silicon, germanium, and lead, is preferable. The negative electrode active material containing these elements can reduce an irreversible capacity.

Among the negative electrode active materials containing these metals, a negative electrode active material containing silicon is preferable. It is possible to increase an electric capacity of the lithium ion secondary battery by using the negative electrode active material containing silicon. Further, in general, the negative electrode active material containing silicon expands and contracts largely (for example, about five times) accompanied by charge and discharge. However, the composite particles according to the present invention have strength capable of withstanding the expansion and the contraction of the negative electrode active material containing silicon. Therefore, a negative electrode manufactured using the composite particles according to the present invention can effectively suppress deterioration of battery performance due to the expansion and the contraction of the negative electrode active material containing silicon.

Examples of the negative electrode active material containing silicon include a compound containing silicon (hereinafter, sometimes referred to as “silicon-containing compound”) and metallic silicon. The silicon-containing compound is a compound of silicon and another element. Examples thereof include SiO, SiO₂, SiOₓ (0.01≦x<2), SiC, and SiOC. Among them, SiOₓ, SiOC, and SiC are preferable. SiOₓ and SiOC are more preferable from a viewpoint of a battery life, and SiOₓ is particularly preferable from a viewpoint of suppressing expansion of the negative electrode. Here, SiOₓ is a compound which can be formed of SiO and/or SiO₂, and metallic silicon. This SiOₓ can be manufactured, for example, by cooling and precipitating silicon monoxide gas generated by heating a mixture of SiO₂ and metallic silicon.

Further, when the silicon-containing compound is used as a negative electrode active material, a blending amount of the silicon-containing compound in the negative electrode active material is preferably 1 to 50% by weight, more preferably 5 to 40% by weight, and particularly preferably 10 to 30% by weight. When the blending amount of the silicon-containing compound is too small, a capacity is small when a lithium ion secondary battery is manufactured. Also, when the blending amount of the silicon-containing compound is too large, a negative electrode swells.

Furthermore, one kind of the negative electrode active material may be used alone, or two or more kinds thereof may be used in combination at an arbitrary ratio.

The negative electrode active material is preferably adjusted to be particulate. Here, when the shape of the particles of the negative electrode active material is spherical, an electrode having a high density can be obtained when a negative electrode is formed. Further, a volume average particle diameter of the negative electrode active material for a lithium ion secondary battery is preferably 0.1 to 100 μm, more preferably 0.5 to 50 μm, and still more preferably 0.8 to 20 μm. Moreover, a tap density of the negative electrode active material for a lithium ion secondary battery is not particularly limited, but is preferably 0.6 g/cm³ or more.

Further, examples of the negative electrode active material preferably used when the electrochemical device is a lithium ion capacitor include the negative electrode active material formed of carbon.

(Binder Resin)

The binder resin used in the present invention is not particularly limited as long as the binder resin can bind the negative electrode active materials to each other. A preferable binder resin is a dispersion-type binder resin having a property of being dispersed in a solvent. Examples of the dispersion-type binder resin include a polymer compound such as a silicon-based polymer, a fluorine-containing polymer, a conjugated diene-based polymer, an acrylate-based polymer, polyimide, polyamide, or polyurethane. The fluorine-containing polymer, the conjugated diene-based polymer, and the acrylate-based polymer are preferable. The conjugated diene-based polymer and the acrylate-based polymer are more preferable. Each of these polymers can be used alone, or two or more kinds thereof can be mixed and used as the dispersion-type binder resin.

The fluorine-containing polymer is a polymer containing a monomer unit containing a fluorine atom. Specific examples of the fluorine-containing polymer include polytetrafluoroethylene, polyvinylidene fluoride, tetrafluoroethylene-perfluoroalkyl vinyl ether copolymer, ethylene-tetrafluoroethylene copolymer, ethylene-chlorotrifluoroethylene copolymer, and perfluoroethylene-propene copolymer. Among them, it is preferable to contain polytetrafluoroethylene because the negative electrode active material is easily held due to fibrillation.

The conjugated diene-based polymer is a homopolymer of a conjugated diene-based monomer, a copolymer obtained by polymerizing a monomer mixture including a conjugated diene-based monomer, or a hydrogenated product thereof. As the conjugated diene-based monomer, 1,3-butadiene, 2-methyl-1,3-butadiene, 2,3-dimethyl-1,3-butadiene, 2-chloro-1,3-butadiene, substituted linear chain conjugated pentadienes, or substituted side chain conjugated hexadienes are preferably used. 1,3-butadiene is more preferably used from viewpoints of being able to improve flexibility and enhance resistance to cracking in use for an electrode. Further, two or more kinds of these conjugated diene-based monomers may be included in the monomer mixture.

When the conjugated diene-based polymer is a copolymer of the conjugated diene-based monomer and a monomer copolymerizable therewith, examples of the copolymerizable monomer include an aromatic vinyl-based monomer, olefins, a halogen atom-containing monomer, vinyl esters, vinyl ethers, vinyl ketones, a heterocyclic ring-containing vinyl compound, an α,β-unsaturated nitrile compound, and a vinyl compound containing an acid component.

Specific examples of the conjugated diene-based polymer include a homopolymer of a conjugated diene-based monomer, such as polybutadiene or polyisoprene; a copolymer of an aromatic vinyl-based monomer and a conjugated diene-based monomer which may be carboxy-modified, such as styrene-butadiene copolymer (SBR); a copolymer of a vinyl cyanide-based monomer and a conjugated diene-based monomer, such as acrylonitrile-butadiene copolymer (NBR); hydrogenated SBR, and hydrogenated NBR.

A ratio of the conjugated diene-based monomer unit in the conjugated diene-based polymer is preferably 20 to 60% by weight, and more preferably 30 to 55% by weight. When the ratio of the conjugated diene-based monomer unit is too large, resistance to electrolytic solution tends to be lowered when a negative electrode is manufactured using composite particles including a binder resin. When the ratio of the conjugated diene-based monomer unit is too small, there is a tendency that sufficient adhesion between the composite particles and a current collector cannot be obtained.

The acrylate-based polymer is a polymer including a monomer unit derived from a compound [(meth)acrylic acid ester] represented by a general formula (1): CH₂═CR¹—COOR² (In the formula, R¹ represents a hydrogen atom or a methyl group, R² represents an alkyl group or a cycloalkyl group, and R² may further contain an ether group, a hydroxyl group, a phosphate group, an amino group, a carboxyl group, a fluorine atom, or an epoxy group.) Specifically, the acrylate-based polymer is a homopolymer of the compound represented by the general formula (1), or a copolymer obtained by polymerizing a monomer mixture including the compound represented by the general formula (1). Specific examples of the compound represented by the general formula (1) include a (meth)acrylic acid alkyl ester such as methyl(meth)acrylate, ethyl(meth)acrylate, propyl(meth)acrylate, isopropyl(meth)acrylate, n-butyl(meth)acrylate, isobutyl(meth)acrylate, cyclohexyl(meth)acrylate, 2-ethylhexyl(meth)acrylate, isopentyl(meth)acrylate, isooctyl(meth)acrylate, isobornyl(meth)acrylate, isodecyl(meth)acrylate, lauryl(meth)acrylate, stearyl(meth)acrylate, or tridecyl(meth)acrylate; an ether group-containing (meth)acrylic acid ester such as butoxyethyl(meth)acrylate, ethoxy diethylene glycol(meth)acrylate, methoxy dipropylene glycol(meth)acrylate, methoxy polyethylene glycol(meth)acrylate, phenoxyethyl(meth)acrylate, or tetrahydrofurfuryl(meth)acrylate; a hydroxyl group-containing (meth)acrylic acid ester such as 2-hydroxyethyl(meth)acrylate, 2-hydroxypropyl(meth)acrylate, 2-hydroxy-3-phenoxypropyl(meth)acrylate, or 2-(meth)acryloyloxyethyl-2-hydroxyethyl phthalate; a carboxylic acid-containing (meth)acrylic acid ester such as 2-(meth)acryloyloxyethyl phthalate or 2-(meth)acryloyloxyethyl phthalate; a fluorine group-containing (meth)acrylic acid ester such as perfluorooctylethyl(meth)acrylate; a phosphate group-containing (meth)acrylic acid ester such as ethyl phosphate(meth)acrylate; an epoxy group-containing (meth)acrylic acid ester such as glycidyl(meth)acrylate; and an amino group-containing (meth)acrylic acid ester such as dimethylaminoethyl(meth)acrylate.

Note that, in the present specification, “(meth)acryl” means “acryl” and “methacryl.” In addition, “(meth)acryloyl” means “acryloyl” and “methacryloyl.”

Each of these (meth)acrylic acid esters can be used alone, or two or more kinds thereof can be used in combination. Among them, a (meth)acrylic acid alkyl ester is preferable. Methyl(meth)acrylate, ethyl(meth)acrylate, n-butyl(meth)acrylate, and a (meth)acrylic acid alkyl ester containing an alkyl group having 6 to 12 carbon atoms are more preferable. By selecting these (meth)acrylic acid alkyl esters, it is possible to reduce a swelling property with respect to an electrolytic solution, and to improve the cycle characteristics.

Further, when the acrylate-based polymer is a copolymer of the compound represented by the general formula (1) and a monomer copolymerizable therewith, examples of the copolymerizable monomer include carboxylic acid esters containing two or more carbon-carbon double bonds, an aromatic vinyl-based monomer, an amide-based monomer, olefins, a diene-based monomer, vinyl ketones, a heterocyclic ring-containing vinyl compound, an α,β-unsaturated nitrile compound, and a vinyl compound containing an acid component.

Among the copolymerizable monomers, the aromatic vinyl-based monomer is preferably used, from viewpoints that high resistance to deformation and high strength can be obtained, and sufficient adhesion between the negative electrode active material layer and the current collector is obtained when an electrode (negative electrode) is manufactured. Examples of the aromatic vinyl-based monomer include styrene.

A ratio of the aromatic vinyl-based monomer in the dispersion-type binder resin is preferably 20 to 85% by weight, more preferably 30 to 75% by weight, and still more preferably 35 to 70% by weight.

Note that, when the ratio of the aromatic vinyl-based monomer is too large, there is a tendency that sufficient adhesion between the negative electrode active material layer and the current collector cannot be obtained. Also, when the ratio of the aromatic vinyl-based monomer is too small, resistance to electrolytic solution tends to be lowered when a negative electrode is manufactured.

A ratio of the (meth)acrylic acid ester unit in the acrylate-based polymer is preferably 50 to 95% by weight, and more preferably 60 to 90% by weight from viewpoints of being able to improve flexibility and enhancing resistance to cracking in use for an electrode (negative electrode).

Examples of the α,β-unsaturated nitrile compound used for the polymer included in the dispersion-type binder resin include acrylonitrile, methacrylonitrile, α-chloro acrylonitrile, and α-bromo acrylonitrile. Each of these α,β-unsaturated nitrile compounds can be used alone, or two or more kinds thereof can be used in combination. Among them, acrylonitrile and methacrylonitrile are preferable, and acrylonitrile is more preferable.

A ratio of the α,β-unsaturated nitrile compound unit in the dispersion-type binder resin is preferably 0.1 to 40% by weight, more preferably 0.5 to 30% by weight, and still more preferably 1 to 20% by weight. When the dispersion-type binder resin includes the α,β-unsaturated nitrile compound unit, high resistance to deformation and high strength can be obtained when an electrode (negative electrode) is manufactured. In addition, when the dispersion-type binder resin includes the α,β-unsaturated nitrile compound unit, adhesion between the negative electrode active material layer including composite particles and the current collector can be sufficient.

Note that, when the ratio of the α,β-unsaturated nitrile compound unit is too large, there is a tendency that sufficient adhesion between the negative electrode active material layer and the current collector cannot be obtained. Also, when the ratio of the α,β-unsaturated nitrile compound unit is too small, resistance to electrolytic solution tends to be lowered when a negative electrode is manufactured.

Examples of the vinyl compound containing an acid component include acrylic acid, methacrylic acid, itaconic acid, maleic acid, and fumaric acid. Each of these vinyl compound containing an acid component can be used alone, or two or more kinds thereof can be used in combination. Among them, acrylic acid, methacrylic acid, and itaconic acid are preferable, and methacrylic acid and itaconic acid are more preferable. Methacrylic acid and itaconic acid may be used together in order to further improve adhesion.

A ratio of the vinyl compound unit containing an acid component in the dispersion-type binder resin is preferably 0.5 to 10% by weight, more preferably 1 to 8% by weight, and still more preferably 2 to 7% by weight from a viewpoint of improving stability in use for a slurry for composite particles.

Note that, when the ratio of the vinyl compound unit containing an acid component is too large, the viscosity of the slurry for composite particles is high, and it tends to become difficult to handle the slurry. Also, when the blending amount of the vinyl compound unit containing an acid component is too small, the stability of the slurry for composite particles tends to be lowered.

The shape of the dispersion-type binder resin is not particularly limited, but is preferably particulate. By being particulate, an excellent binding property is obtained, and it is possible to suppress reduction in a capacity of a manufactured electrode and deterioration of the electrode due to repeated charge and discharge. Examples of the particulate binder resin include binder resin particles in a state that the binder resin particles are dispersed in water, such as latex, and binder resin particles in a powder form obtained by drying such a dispersion.

An average particle diameter of the dispersion-type binder resin is preferably 0.001 to 100 μm, more preferably 10 to 1000 nm, and still more preferably 50 to 500 nm from a viewpoint of obtaining a negative electrode having excellent strength and flexibility with excellent stability in use for the slurry for composite particles.

Further, a method for manufacturing the binder resin used in the present invention is not particularly limited. It is possible to use a well-known polymerization method such as an emulsion polymerization method, a suspension polymerization method, a dispersion polymerization method, or a solution polymerization method. Among these methods, the emulsion polymerization method is preferable because it is easy to control the particle diameter of the binder resin. Furthermore, the binder resin used in the present invention may be particles having a core-shell structure obtained by polymerizing a mixture of two or more kinds of monomers in stages.

An amount of the binder resin is, on a dry weight basis, preferably 0.1 to 50 parts by weight, more preferably 0.5 to 20 parts by weight, and still more preferably 1 to 15 parts by weight with respect to 100 parts by weight of the negative electrode active material, from viewpoints of being able to sufficiently secure adhesion between the resulting negative electrode active material layer and the current collector, and to lower internal resistance of the electrochemical device.

(Water-Soluble Polymer)

A water-soluble polymer used in the present invention is a polymer having an insoluble matter of less than 1.0% by weight when 0.5 g of the polymer is dissolved in 100 g of water at 25° C.

Specific examples of the water-soluble polymer include a cellulose-based polymer such as carboxymethyl cellulose, methyl cellulose, ethyl cellulose, or hydroxypropyl cellulose, an ammonium salt or an alkali metal salt thereof, an alginic acid ester such as propylene glycol alginate, an alginate such as sodium alginate, polyacrylic acid, polyacrylate (or methacrylate) such as sodium polyacrylate (or methacrylate), polyvinyl alcohol, modified polyvinyl alcohol, polyethylene oxide, polyvinyl pyrrolidone, polycarboxylic acid, oxidized starch, starch phosphate, casein, various modified starch, chitin, and a chitosan derivative. Note that, in the present invention, “(modified) poly” means “unmodified poly” or “modified poly.”

Each of these water-soluble polymers can be used alone, or two or more kinds thereof can be used in combination.

Among them, the cellulose-based polymer is preferable, and carboxymethyl cellulose, or an ammonium salt or an alkali metal salt thereof is particularly preferable. A blending amount of these water-soluble polymers is not particularly limited in a range of not damaging an effect of the present invention, but is preferably 0.1 to 10 parts by weight, more preferably 0.1 to 5 parts by weight, and still more preferably 0.1 to 2 parts by weight with respect to 100 parts by weight of the negative electrode active material.

(Water-Insoluble Polysaccharide Polymer Fibers)

Water-insoluble polysaccharide polymer fibers used in the present invention are fibers (short fibers) fibrillated by a mechanical shear force. Note that, the water-insoluble polysaccharide polymer fibers used in the present invention are polysaccharide polymer fibers having an insoluble matter of 80% by weight or more when 0.5 g of the polysaccharide polymer fibers are dissolved in 100 g of water at 25° C.

As the water-insoluble polysaccharide polymer fibers, polysaccharide polymer nanofibers are preferably used. Among the polysaccharide polymer nanofibers, it is preferable to use one or any mixture selected from bio-nanofibers derived from an organism, such as cellulose nanofibers, chitin nanofibers, or chitosan nanofibers, from a viewpoint of having a high reinforcing effect of the composite particles due to flexibility and high strength.

Examples of a method for fibrillating (making short fibers of) these water-insoluble polysaccharide polymer fibers by applying a mechanical shear force thereto include a method of beating the water-insoluble polysaccharide polymer fibers and a method of making the water-insoluble polysaccharide polymer fibers pass through an orifice, after the water-insoluble polysaccharide polymer fibers are dispersed in water. Furthermore, short fibers of the water-insoluble polysaccharide polymer fibers having various fiber diameters are commercially available, and may be dispersed in water to be used.

An average fiber diameter of the water-insoluble polysaccharide polymer fibers used in the present invention is preferably 5 to 3000 nm, more preferably 5 to 2000 nm, still more preferably 5 to 1000 nm, and particularly preferably 5 to 100 nm, from viewpoints of obtaining composite particles and an electrode (negative electrode) having excellent strength and obtaining an electrochemical device having excellent electrochemical characteristics. When the average fiber diameter of the water-insoluble polysaccharide polymer fibers is too large, the water-insoluble polysaccharide polymer fibers cannot exist sufficiently in the composite particles, so that the strength of the composite particles cannot be sufficient. In addition, fluidity of the composite particles is deteriorated, and it is difficult to form a uniform negative electrode active material layer.

Note that, in the water-insoluble polysaccharide polymer fibers, single fibers may be separated sufficiently from each other without being aligned. In this case, the average fiber diameter is an average of diameters of the single fibers. In addition, in the water-insoluble polysaccharide polymer fibers, a plurality of single fibers may be assembled in a bundle to form a single yarn. In this case, the average fiber diameter is defined as an average value of diameters of the single yarns.

Further, a polymerization degree of the water-insoluble polysaccharide polymer fibers is preferably 50 to 1000, and more preferably 100 to 600, from viewpoints of obtaining composite particles and an electrode (negative electrode) having excellent strength and obtaining an electrochemical device having excellent electrochemical characteristics because of a uniform negative electrode active material layer formed. When the polymerization degree of the water-insoluble polysaccharide polymer fibers is too large, internal resistance of the resulting electrochemical device is increased. In addition, it is difficult to form a uniform negative electrode active material layer. Also, when the polymerization degree of the water-insoluble polysaccharide polymer fibers is too small, strength of the composite particles is insufficient.

A blending amount of the water-insoluble polysaccharide polymer fibers is preferably 0.2 to 4 parts by weight, more preferably 0.5 to 4 parts by weight, still more preferably 1 to 3 parts by weight, and particularly preferably 1 to 2 parts by weight, with respect to 100 parts by weight of the composite particles. When the blending amount of the water-insoluble polysaccharide polymer fibers is too large, internal resistance of the resulting electrochemical device is increased. In addition, it is difficult to form a uniform electrode layer (negative electrode active material layer). Also, when the blending amount of the water-insoluble polysaccharide polymer fibers is too small, strength of the composite particles is insufficient. Note that, when a viscosity of the slurry for composite particles is increased by increasing the blending amount of the water-insoluble polysaccharide polymer fibers, the viscosity can be appropriately adjusted by decreasing the blending amount of the water-soluble polymer.

(Electroconductive Auxiliary Agent)

The composite particles for an electrochemical device electrode according to the present invention may include an electroconductive auxiliary agent if necessary in addition to the above-described components.

The electroconductive auxiliary agent is not particularly limited as long as it has electroconductivity. However, a particulate material having electroconductivity is preferable. Examples thereof include conductive carbon black such as furnace black, acetylene black, or Ketjen black; graphite such as natural graphite or artificial graphite; and carbon fibers such as polyacrylonitrile-based carbon fibers, pitch-based carbon fibers, or vapor grown carbon fibers. When the electroconductive auxiliaty agent is particulate material, an average particle diameter of the particulate electroconductive auxiliary agent is not particularly limited. However, the average particle diameter thereof is preferably smaller than that of the negative electrode active material, and is preferably 0.001 to 10 μm, more preferably 0.05 to 5 μm, and still more preferably 0.1 to 1 μm, from a viewpoint of exhibiting sufficient electroconductivity with a smaller use amount.

A blending amount of the electroconductive auxiliary agent in the composite particles for an electrochemical device electrode according to the present invention is preferably 0.1 to 50 parts by weight, more preferably 0.5 to 15 parts by weight, and still more preferably 1 to 10 parts by weight with respect to 100 parts by weight of the negative electrode active material, from a viewpoint of sufficiently lowering internal resistance while maintaining a high capacity of the resulting electrochemical device.

(Manufacturing Composite Particles)

Composite particles are obtained by granulating using the negative electrode active material, the binder resin, the water-soluble polymer, the water-insoluble polysaccharide polymer, the electroconductive auxiliary agent added if necessary, and the like. The composite particles include the negative electrode active material and the binder resin. Each of the negative electrode active material and the binder resin does not exist as independent particles, but one particle is formed of two or more components including the negative electrode active material and the binder resin as constituting components. Specifically, a plurality of particles is combined to each other to form a secondary particle while an individual particle including above-mentioned two or more components substantially maintains a shape thereof. A particle formed by binding a plurality of (preferably several to several dozen) negative electrode active materials with the binder resin is preferable.

The shape of the composite particle is preferably substantially spherical from a viewpoint of fluidity. That is, when a minor axis diameter of the composite particle is Lₛ, a major axis diameter thereof is Lₗ, (Lₐ=(Lₛ+Lₗ)/2), and a value of (1−(Lₗ−Lₛ)/Lₐ)×100 is used as sphericity (%), the sphericity is preferably 80% or more, and more preferably 90% or more. Here, the minor axis diameter L, and the major axis diameter Lₗ are measured with a scanning electron microscope photographic image.

An average particle diameter of the composite particles is preferably 0.1 to 200 μm, more preferably 1 to 150 μm, and still more preferably 10 to 80 μm, from a viewpoint of being able to easily obtain an electrode layer (negative electrode active material layer) having a desired thickness. Note that, in the present invention, the average particle diameter is a volume average particle diameter measured by a laser diffraction type particle size distribution measuring apparatus (for example, SALD-3100; manufactured by Shimadzu Corporation) and calculated.

A method for manufacturing the composite particles is not particularly limited. However, the composite particles can be obtained by a manufacturing method such as a spray drying granulation method, a rolling bed granulation method, a compression-type granulation method, an agitation-type granulation method, an extrusion granulation method, a crushing-type granulation method, a fluidized bed granulation method, a fluidized bed multifunctional granulation method, or a melt granulation method.

As the method for manufacturing the composite particles, an optimum method may be appropriately selected according to the components of the composite particles or the like from viewpoints of easiness of controlling the particle diameter, productivity, easiness of controlling a particle diameter distribution, and the like. However, the spray drying granulation method described below is preferable because the composite particles can be manufactured relatively easily. Hereinafter, the spray drying granulation method will be described.

First, a slurry for composite particles including the negative electrode active material and the binder resin (hereinafter, sometimes referred to as “slurry”) is prepared. The slurry for composite particles can be prepared by dispersing or dissolving the negative electrode active material, the binder resin, the water-soluble polymer, the water-insoluble polysaccharide polymer fibers, and the electroconductive auxiliary agent added if necessary in a solvent. Note that, in this case, when the binder resin is dispersed in water as a solvent, the binder resin can be added while being dispersed in water.

As the solvent used to obtain the slurry for composite particles, water is preferably used. However, a mixed solvent of water and an organic solvent may be used. One of only the organic solvents may be used alone, or several kinds thereof may be used in combination. Examples of the organic solvent usable in this case include alcohols such as methyl alcohol, ethyl alcohol, or propyl alcohol; alkyl ketones such as acetone or methyl ethyl ketone; ethers such as tetrahydrofuran, dioxane, or diglyme; and amides such as diethylformamide, dimethyl acetamide, N-methyl-2-pyrrolidone, or dimethyl imidazolidinone. When an organic solvent is used, alcohols are preferable. By using water and an organic solvent having a boiling point lower than that of water together, a drying speed can be increased during spray drying. In addition, this makes it possible to adjust the viscosity and the fluidity of the slurry for composite particles, and to enhance production efficiency.

Further, the viscosity of the slurry for composite particles is preferably 10 to 3,000 mPa·s, more preferably 30 to 1,500 mPa·s, and still more preferably 50 to 1,000 mPa·s at room temperature, from a viewpoint of improving productivity of a spray drying granulation step.

Furthermore, in the present invention, when the slurry for composite particles is prepared, a dispersing agent or a surfactant may be added if necessary. Examples of the surfactant include an anionic surfactant, a cationic surfactant, a nonionic surfactant, and an amphoteric surfactant such as a nonionic anion. However, the anionic surfactant or the nonionic surfactant easily thermally decomposed is preferable. A blending amount of the surfactant is preferably 50 parts by weight or less, more preferably 0.1 to 10 parts by weight, and still more preferably 0.5 to 5 parts by weight, with respect to 100 parts by weight of the negative electrode active material.

An amount of a solvent used when the slurry is prepared is preferably 1 to 50% by weight, more preferably 5 to 50% by weight, and still more preferably 10 to 40% by weight in a solid content concentration of the slurry, from a viewpoint of dispersing the binder resin uniformly in the slurry.

A method or order of dispersing or dissolving the negative electrode active material, the binder resin, the water-soluble polymer, the water-insoluble polysaccharide polymer fibers, and the electroconductive auxiliary agent added if necessary in a solvent is not particularly limited. Examples thereof include a method of adding and mixing the negative electrode active material, the binder resin, the water-soluble polymer, the water-insoluble polysaccharide polymer fibers, and the electroconductive auxiliary agent to a solvent, a method of dissolving the water-soluble polymer in a solvent, then adding and mixing the negative electrode active material, the electroconductive auxiliary agent and the water-insoluble polysaccharide polymer fibers thereto, and finally adding and mixing the binder resin (for example, latex) dispersed in a solvent thereto, and a method of adding and mixing the negative electrode active material and the electroconductive auxiliary agent to the binder resin and the water-insoluble polysaccharide polymer fibers dispersed in a solvent, and adding and mixing the water-soluble polymer dissolved in a solvent to this mixture.

Further, as a mixing apparatus, for example, it is possible to use a ball mill, a sand mill, a bead mill, a pigment dispersing machine, a grinding machine, an ultrasonic dispersing machine, a homogenizer, a homomixer, or a planetary mixer. Mixing is preferably performed at room temperature to 80° C. for ten minutes to several hours.

Subsequently, the obtained slurry for composite particles is subjected to spray drying and granulated. Spray drying is a method of spraying the slurry into hot air and drying it. Examples of an apparatus used for spraying the slurry include an atomizer. As the atomizer, two types of apparatuses, that is, a rotary disk method and a pressing method are exemplified. In the rotary disc method, the slurry is introduced into approximately the center of the disk to be rotated at high speed, the slurry is emitted outside the disk by a centrifugal force of the disk, and the slurry is sprayed at that time. In the rotary disk method, the rotational speed of the disk depends on the size of the disc, but is preferably 5,000 to 30,000 rpm and more preferably 15,000 to 30,000 rpm. As the rotational speed of the disk is decreased, spray droplets become larger and the average particle diameter of the resulting composite particles becomes larger. Examples of the atomizer of the rotary disk method include a pin type and a vane type, but the pin type atomizer is preferable. The pin type atomizer is a kind of centrifugal spraying apparatus using a spray disc. The spray disc includes a plurality of spray rollers, disposed between upper and lower mounting discs detachably and substantially concentrically along peripheries thereof. The slurry for composite particles is introduced from the center of the spray disc, is attached to the spray rollers by a centrifugal force, moves on the surfaces of the rollers to the outside, and is finally separated from the surfaces of the rollers to be sprayed. On the other hand, in the pressing method, the slurry for composite particles is pressurized, sprayed from a nozzle, and dried.

The temperature of the slurry for composite particles to be sprayed is preferably room temperature, but may be a temperature higher than room temperature by heating. In addition, the hot air temperature during spray drying is preferably 25 to 250° C., more preferably 50 to 200° C., and still more preferably 80 to 150° C. In the spray drying method, a method for blowing the hot air is not particularly limited. Examples thereof include a method in which the hot air flows in parallel with a spray direction in a transverse direction, a method in which droplets are sprayed in a drying tower apex and go down along with the hot air, a method in which the sprayed droplets and the hot air are subjected to counterflow contact, and a method in which the sprayed droplets first flow in parallel with the hot air, then fall by gravity, and are subjected to counterflow contact with the hot air.

(Electrochemical Device Electrode)

The electrochemical device electrode according to the present invention is a negative electrode obtained by laminating a negative electrode active material layer including the composite particles on a current collector. As a material of the current collector, for example, metal, carbon, or an electroconductive polymer can be used, and metal is preferably used. As metal, generally, copper, aluminum, platinum, nickel, tantalum, titanium, stainless steel, an alloy, or the like is used. Among them, copper, aluminum, or an aluminum alloy is preferably used from viewpoints of electroconductivity and voltage resistance. Further, when high voltage resistance is required, high-purity aluminum disclosed in JP 2001-176757 A or the like can be preferably used. The current collector is a film or a sheet. The thickness thereof is appropriately selected according to the intended use, but is preferably 1 to 200 μm, more preferably 5 to 100 μm, and more preferably 10 to 50 μm.

When the negative electrode active material layer is laminated on the current collector, the composite particles may be molded into a sheet, and then the sheet may be laminated on the current collector. However, the composite particles are preferably directly subjected to pressure molding on the current collector. Examples of the pressure molding method are as follows. That is, in a roll pressure molding method, using a roll-type pressure molding apparatus including a pair of rolls, while the current collector is sent with the rolls, the composite particles are supplied to the roll-type pressure molding apparatus with a supplying apparatus such as a screw feeder, and the negative electrode active material layer is thereby molded on the current collector. In another method, the composite particles are sprayed on the current collector, leveled with a blade or the like to adjust the thickness, and then subjected to molding with a pressure apparatus. In still another method, a mold is filled with the composite particles, and the mold is pressurized for molding. Among them, the roll pressure molding method is preferable. Particularly, the composite particles according to the present invention have high fluidity, so that the high fluidity makes molding by roll pressure molding possible. This enables improvement of productivity.

The roll temperature during the roll pressure molding is preferably 25 to 200° C., more preferably 50 to 150° C., and still more preferably from 80 to 120° C. from a viewpoint of being able to obtain sufficient adhesion between the negative electrode active material layer and the current collector. Further, press linear pressure between the rolls during the roll pressure molding is preferably 10 to 1000 kN/m, more preferably 200 to 900 kN/m , and still more preferably from 300 to 600 kN/m from a viewpoint of being able to improve the uniformity of the thickness of the negative electrode active material layer. Furthermore, a molding speed during the roll pressure molding is preferably 0.1 to 20 m/min, and more preferably 4 to 10 m/min.

Further, in order to eliminate variations in the thickness of the molded electrochemical device electrode (negative electrode), and to increase the capacity by increasing the density of the negative electrode active material layer, post-pressure may be further applied if necessary. A method of the post-pressure is preferably applied in a press step with a roll. In the roll press step, two cylindrical rolls are vertically arranged in parallel at narrow intervals, and are rotated in opposite directions to each other. An electrode is pinched between the rolls to be pressurized. At this time, the rolls may be subjected to temperature adjustment such as heating or cooling, if necessary.

The density of the negative electrode active material layer is not particularly limited, but is generally 0.30 to 10 g/cm³, preferably 0.35 to 8.0 g/cm³, and more preferably 0.40 to 6.0 g/cm³. Further, the thickness of the negative electrode active material layer is not particularly limited, but is generally 5 to 1000 μm, preferably 20 to 500 μm, and more preferably 30 to 300 μm.

(Electrochemical Device)

The electrochemical device according to the present invention uses the electrochemical device electrode obtained as described above as a negative electrode, and further includes a positive electrode, a separator and an electrolytic solution. Examples of the electrochemical device include a lithium ion secondary battery, and a lithium ion capacitor.

(Positive Electrode)

The positive electrode of the electrochemical device is obtained by laminating a positive electrode active material layer on a current collector. The positive electrode of the electrochemical device can be obtained by applying a slurry for a positive electrode including a positive electrode active material, a binder resin for a positive electrode, a solvent used for manufacturing the positive electrode, and a water-soluble polymer, an electroconductive auxiliary agent, and the like to be used if necessary, to a surface of the current collector and drying. That is, the positive electrode active material layer is formed on the current collector by applying and drying the slurry for a positive electrode on the surface of the current collector.

(Positive Electrode Active Material)

When the electrochemical device is a lithium ion secondary battery, as the positive electrode active material, an active material capable of doping and dedoping a lithium ion is used, and is roughly classified into that composed of an inorganic compound and that composed of an organic compound.

Examples of the positive electrode active material composed of an inorganic compound include a transition metal oxide, a transition metal sulfide, and a lithium-containing composite metal oxide consisting of lithium and a transition metal. As the transition metal, Ti, V, Cr, Mn, Fe, Co, Ni, Cu, Mo, or the like is used.

Examples of the transition metal oxide include MnO, MnO₂, V₂O₅, V₆O₁₃, TiO₂, Cu₂V₂O₃, amorphous V₂O—P₂O₅, MoO₃, V₂O₅, and V₆O₁₃. Among them, MnO, V₂O₅, V₆O₁₃, and TiO₂ are preferable from viewpoints of cycle stability and capacity. Examples of the transition metal sulfide include TiS₂, TiS₃, amorphous MoS₂, and FeS. Examples of the lithium-containing composite metal oxide include a lithium-containing composite metal oxide having a layered structure, a lithium-containing composite metal oxide having a spinel structure, and a lithium-containing composite metal oxide having an olivine type structure.

Examples of the lithium-containing composite metal oxide having a layered structure include a lithium-containing cobalt oxide (LiCoO₂) (hereinafter, sometimes referred to as “LCO”), a lithium-containing nickel oxide (LiNiO₂), a Co—Ni—Mn lithium composite oxide, a Ni—Mn—Al lithium composite oxide, and a Ni—Co—Al lithium composite oxide. Examples of the lithium-containing composite metal oxide having a spinel structure include lithium manganese oxide (LiMn₂O₄) and Li[Mn_{3/2}M_{1/2}]O₄ (here, M is Cr, Fe, Co, Ni, Cu, or the like) in which Mn in lithium manganese oxide is partially replaced by another transition metal. Examples of the lithium-containing composite metal oxide having an olivine type structure include an olivine-type lithium phosphate compound represented by LiₓMPO₄ (In the formula, M is at least one selected from Mn, Fe, Co, Ni, Cu, Mg, Zn, V, Ca, Sr, Ba, Ti, Al, Si, B, and Mo, 0≦X≦2).

As the organic compound, for example, an electroconductive polymer such as polyacetylene or poly-p-phenylene can be used. An iron-based oxide having poor electrical conductivity may be used as a positive electrode active material covered with a carbon material while a carbon source material exists during reduction firing. Also, these compounds may have been subjected to partial element substitution. The positive electrode active material may be a mixture of the above-described inorganic compound and organic compound.

When the electrochemical device is a lithium ion capacitor, the positive electrode active material may be a material which can reversibly carry a lithium ion and an anion such as tetrafluoroborate. Specifically, an allotrope of carbon can be preferably used. An electrode active material for use in an electric double layer capacitor can be widely used. Specific examples of the allotrope of carbon include activated carbon, polyacene (PAS), a carbon whisker, a carbon nanotube, and graphite.

A volume average particle diameter of the positive electrode active material is preferably 1 to 50 μm, and more preferably 2 to 30 μm, from viewpoints of being able to reduce a blending amount of the binder resin for a positive electrode at the time of preparing a slurry for a positive electrode and to suppress a decrease in the capacity of the battery, and from viewpoints of easily preparing the slurry for a positive electrode having a proper viscosity for applying and being able to obtain a uniform electrode.

(Binder Resin for Positive Electrode)

Examples of the binder resin for a positive electrode include a resin such as polyethylene, polytetrafluoroethylene (PTFE), polyvinylidene fluoride (PVDF), a tetrafluoroethylene-hexafluoropropylene copolymer (FEP), a polyacrylic acid derivative, or a polyacrylonitrile derivative; and a soft polymer such as an acrylate-based soft polymer, a diene-based soft polymer, an olefin-based soft polymer, or a vinyl-based soft polymer. Note that, one kind of the binder resins may be used alone, or two or more kinds thereof may be used in combination at an arbitrary ratio.

(Other Components)

As the water-soluble polymer and the electroconductive auxiliary agent used for the slurry for a positive electrode if necessary, the water-soluble polymer and the electroconductive auxiliary agent which can be used for the above-described composite particles can be used, respectively.

(Solvent Used for Manufacturing Positive Electrode)

As a solvent used for manufacturing the positive electrode, either water or an organic solvent may be used. Examples of the organic solvent include cycloaliphatic hydrocarbons such as cyclopentane or cyclohexane; aromatic hydrocarbons such as toluene or xylene, ketones such as ethyl methyl ketone or cyclohexanone; esters such as ethyl acetate, butyl acetate, γ-butyrolactone, or ε-caprolactone; acylonitriles such as acetonitrile or propionitrile; ethers such as tetrahydrofuran or ethylene glycol diethyl ether; alcohols such as methanol, ethanol, isopropanol, ethylene glycol, or ethylene glycol monomethyl ether; and amides such as N-methylpyrrolidone or N,N-dimethylformamide. Among them, N-methylpyrrolidone (NMP) is preferable. Note that, one kind of the solvents may be used alone, or two or more kinds thereof may be used in combination at an arbitrary ratio. Among them, water is preferably used as the solvent.

An amount of the solvent is only required to be adjusted such that the viscosity of the slurry for a positive electrode is suitable for application. Specifically, the amount of the solvent is adjusted for use such that the solid content concentration of the slurry for a positive electrode is preferably 30 to 90% by weight, and more preferably 40 to 80% by weight.

(Current Collector)

As the current collector used for a positive electrode, a current collector similar to the current collector used for the above-described electrochemical device electrode (negative electrode) can be used.

(Method for Manufacturing Positive Electrode)

A method for applying the slurry for a positive electrode on the surface of the current collector is not particularly limited. Examples thereof include a doctor blade method, a dipping method, a reverse roll method, a direct roll method, a gravure method, an extrusion method, and a brush coating method.

Examples of a drying method include drying by warm air, hot air, or low humidity air, vacuum drying, and drying by irradiation with (far) infrared rays, an electron beam, or the like. Drying time is preferably 5 minutes to 30 minutes, and drying temperature is preferably 40 to 180° C.

Further, after applying and drying the slurry for a positive electrode on the surface of the current collector, if necessary, for example, using a mold press or a roll press, the positive electrode active material layer is preferably subjected to a pressure treatment. It is possible to reduce porosity of the positive electrode active material layer by subjecting to the pressure treatment. The porosity is preferably 5% or more, more preferably 7% or more, preferably 30% or less, and more preferably 20% or less. When the porosity is too large, a high volume capacity is hardly obtained, and the positive electrode active material layer is easily peeled off from the current collector. Also, when the porosity is too small, rate characteristics are deteriorated.

Furthermore, when the positive electrode active material layer includes a curable polymer, it is preferable to cure the polymer after the positive electrode active material layer is formed.

The density of the positive electrode active material layer is not particularly limited, but is generally 0.30 to 10 g/cm³, preferably 0.35 to 8.0 g/cm³, and more preferably 0.40 to 6.0 g/cm³. Further, the thickness of the positive electrode active material layer is not particularly limited, but is generally 5 to 1000 μm, preferably 20 to 500 μm, and more preferably 30 to 300 μm.

(Separator)

As the separator, a microporous film or non-woven fabric including a polyolefin resin such as polyethylene or polypropylene, or an aromatic polyamide resin; a porous resin coating including inorganic ceramic powder; or the like can be used. Specific examples thereof include a microporous film formed of a resin such as a polyolefin-based (polyethylene, polypropylene, polybutene, polyvinyl chloride), a mixture thereof, or a copolymer thereof; a microporous film formed of a resin such as polyethylene terephthalate, polycycloolefin, polyether sulfone, polyamide, polyimide, polyimide amide, polyaramide, polycycloolefin, nylon, or polytetrafluoroethylene; woven polyolefin-based fibers or non-woven fabric thereof; and aggregates of insulating material particles. Among them, the microporous film formed of a polyolefin-based resin is preferable because it is possible to reduce the thickness of the entire separator, and to increase the capacity per volume by increasing the active material ratio in the lithium ion secondary battery.

The thickness of the separator is preferably 0.5 to 40 μm, more preferably 1 to 30 μm, and still more preferably 1 to 25 μm from viewpoints of being able to reduce the internal resistance due to the separator in the lithium ion secondary battery, and of excellent workability in manufacturing the lithium ion secondary battery.

(Electrolytic Solution)

As an electrolytic solution for a lithium ion secondary battery, for example, a non-aqueous electrolytic solution prepared by dissolving a supporting electrolyte in a non-aqueous solvent is used. As the supporting electrolyte, a lithium salt is preferably used. Examples of the lithium salt include LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi, and (C₂F₅SO₂)NLi. Among them, LiPF₆, LiClO₄, and CF₃SO₃Li which are easily dissolved in a solvent and exhibiting a high degree of dissociation are preferable. One kind of these lithium salts may be used alone, or two or more kinds thereof may be used in combination at an arbitrary ratio. The higher the degree of dissociation of the supporting electrolyte to be used is, the higher the lithium ion conductivity is, so that, it is possible to control the lithium ion conductivity depending on the kind of the supporting electrolyte.

The concentration of the supporting electrolyte in the electrolytic solution is preferably 0.5 to 2.5 mol/L depending on the type of the supporting electrolyte. When the concentration of the supporting electrolyte is too low or too high, the ion conductivity may be decreased.

The non-aqueous solvent is not particularly limited as long as the supporting electrolyte can be dissolved in the non-aqueous solvent. Examples of the non-aqueous solvent include carbonates such as dimethyl carbonate (DMC), ethylene carbonate (EC), diethyl carbonate (DEC), propylene carbonate (PC), butylene carbonate (BC), or methylethyl carbonate (MEC); esters such as γ-butyrolactone or methyl formate; ethers such as 1,2-dimethoxyethane or tetrahydrofuran; sulfur-containing compounds such as sulfolane or dimethyl sulfoxide; and ionic liquid used also as the supporting electrolyte. Among them, the carbonates are preferable because they have a high dielectric constant and a wide stable potential region. One kind of the non-aqueous solvents may be used alone, or two or more kinds thereof may be used in combination at an arbitrary ratio. In general, the lower the viscosity of the non-aqueous solvent is, the higher the lithium ion conductivity is. The higher the dielectric constant is, the higher the solubility of the supporting electrolyte is. However, these are in a trade-off relationship, and therefore, the lithium ion conductivity is preferably controlled for use depending on a kind of the solvent and a mixing ratio. Furthermore, the whole or a part of hydrogen atoms in the non-aqueous solvent may be replaced by fluorine atoms, and the obtained solvent may be used as a part or as a whole.

Further, the electrolytic solution may include an additive. Examples of the additive include a carbonate-based compound such as vinylene carbonate (VC); a sulfur-containing compound such as ethylene sulfite (ES); and a fluorine-containing compound such as fluoroethylene carbonate (FEC). One kind of the additives may be used alone, or two or more kinds thereof may be used in combination at an arbitrary ratio.

Note that, as the electrolytic solution for a lithium ion capacitor, a similar electrolytic solution to the electrolytic solution usable for the above-described lithium ion secondary battery can be used.

(Method for Manufacturing Electrochemical Device)

Specific examples of manufacturing an electrochemical device such as a lithium ion secondary battery or a lithium ion capacitor include a method as follows. That is, a positive electrode and a negative electrode are superposed via a separator, are wound or folded according to a battery shape, and are put into a battery container. An electrolytic solution is injected into the battery container, and the opening thereof is sealed. In addition, if necessary, expanded metal; an over-current prevention device such as a fuse or a PTC device; a lead plate, or the like may be put thereinto to prevent an increase of pressure inside the battery, overcharge and overdischarge. A shape of the lithium ion secondary battery may be any of a coin type, a button type, a sheet type, a cylinder type, a square, and a flat type. A material of the battery container is only required to inhibit infiltration of moisture into the battery. The material is not particularly limited, and may be metal, a laminate made of aluminum, or the like.

The composite particles for an electrochemical device electrode according to the present embodiment can provide sufficient strength and sufficient adhesion in forming an electrode.

### EXAMPLES

Hereinafter, the present invention will be specifically described by showing Examples. However, the present invention is not limited to the following Examples, and can be arbitrarily changed to be performed within a range not departing from the gist of the invention and a scope equivalent thereto. Note that, in the following description, “%” and “parts” representing an amount are based on a weight, unless otherwise indicated.

In Examples and Comparative Examples, particle strength of the composite particles, peel strength, and cycle characteristics were evaluated as follows. Further, in the following, an average fiber diameter is an average value obtained when the fiber diameters of 100 water-insoluble polysaccharide polymer fibers in an electron microscopic field are measured.

<Particle Strength of Composite Particles>

Composite particles obtained in Examples and Comparative Examples were subjected to a compression test using a micro-compression tester (“MCT-W500” manufactured by Shimadzu Corporation). In the compression test, a load was applied toward the center of the composite particles at room temperature at a load application rate of 4.46 mN/sec, and compressive strength (MPa) was measured when the particles were deformed until the diameters of the composite particles were displaced by 40%. Note that, in this measurement, composite particles having a diameter of 40 to 60 μm were selected to be subjected to the compression test.

Further, the compression test was performed 10 times, and an average value thereof was used as compressive strength. The compressive strength was evaluated with the following criteria, and the results are shown in Table 1. Note that, it is shown that the larger the compressive strength is, the better the adhesion strength between the negative electrode active materials is, and the better the particle strength of the composite particles is.
A: Compressive strength of 1.00 MPa or more
B: Compressive strength of 0.90 MPa or more and less than 1.00 MPa
C: Compressive strength of 0.80 MPa or more and less than 0.90 MPa
D: Compressive strength of 0.70 MPa or more and less than 0.80 MPa
E: Compressive strength of less than 0.70 MPa

<Peel Strength>

Each of the negative electrodes for a lithium ion secondary battery obtained in Examples and Comparative Examples was cut into a rectangular shape having a width 1 cm×length 10 cm. The cut negative electrode for a lithium ion secondary battery was fixed with the negative electrode active material layer side up, and a cellophane tape was attached to the surface of the negative electrode active material layer. Thereafter, a stress was measured when the cellophane tape was peeled off in a 180° direction from one end of the test piece at a speed of 50 mm/min. This measurement of the stress was performed 10 times, and an average value thereof was used as peel strength. The peel strength was evaluated with the following criteria, and the results are shown in Table 1. Note that, it is shown that the larger the peel strength is, the better adhesion strength in the negative electrode active material layer is, and the better adhesion between the negative electrode active material layer and the current collector is.
A: Peel strength of 15 N/m or more
B: Peel strength of 7 N/m or more and less than 15 N/m
C: Peel strength of 3 N/m or more and less than 7 N/m
D: Peel strength of less than 3 N/m
E: Unable to be evaluated

<Charge-Discharge Cycle Characteristics>

The laminate-type lithium ion secondary batteries obtained in Examples and Comparative Examples were subjected to a charge-discharge cycle test. In the test, the lithium ion secondary batteries were charged at a constant current until 4.2 V by a constant-current constant-voltage charging method of 0.5 C at 60° C., then charged at a constant voltage, and then discharged at a constant current of 0.5 C until 3.0 V. The charge-discharge cycle test was performed up to 100 cycles. A ratio of a discharge capacity in the 100th cycle with respect to an initial discharge capacity was used as a capacity retention ratio. The capacity retention ratio was evaluated with the following criteria, and the results are shown in Table 1. It is shown that the larger the capacity retention ratio is, the less a decrease in the capacity due to repeated charge and discharge is.
A: Capacity retention ratio of 90% or more
B: Capacity retention ratio of 80% or more and less than 90%
C: Capacity retention ratio of 75% or more and less than 80%
D: Capacity retention ratio of 70% or more and less than 75%
E: Capacity retention ratio of less than 70% or unable to be evaluated

### Example 1

(Manufacturing Binder Resin)

47 parts of styrene, 50 parts of 1,3-butadiene, 3 parts of methacrylic acid, 4 parts of sodium dodecylbenzenesulfonate, 150 parts of ion-exchanged water, 0.4 parts of t-dodecylmercaptan as a chain transfer agent, and 0.5 parts of potassium persulfate as a polymerization initiator were put into a 5MPa pressure resistant container with a stirrer, and stirred sufficiently. Thereafter, the resultant mixture was heated to 50° C. and polymerization was started. The reaction was terminated by cooling when a polymerization conversion ratio became 96%. A particulate binder resin (styrene-butadiene copolymer; hereinafter, sometimes abbreviated as “SBR”) was obtained.

(Manufacturing Slurry for Composite Particles)

96.5 parts of artificial graphite (average particle diameter: 24.5 μm, graphite interlayer distance (spacing (d value) of (002) plane by X-ray diffractometry: 0.354 nm) as a negative electrode active material, 1.2 parts in terms of solid content of the binder resin, 0.3 parts in terms of solid content of a 1.0% aqueous solution of carboxymethyl cellulose (hereinafter, sometimes abbreviated as “CMC”) (BSH-12; manufactured by Daiichi Kogyo Seiyaku Co., Ltd.) as a water-soluble polymer, and 2 parts in terms of solid content of a 2% aqueous dispersion of cellulose nanofibers A (BiNFi-s (NMa-10002), fiber diameter: 20 nm, polymerization degree: 500; manufactured by Sugino Machine Limited) as water-insoluble polysaccharide polymer fibers were mixed. In addition, ion-exchanged water was added thereto such that the solid content concentration became 30%. Mixing and dispersing were performed to obtain a slurry for composite particles.

(Manufacturing Composite Particles)

The slurry for composite particles was subjected to spray drying granulation using an atomizer of the rotary disk method (diameter: 65 mm) in a spray dryer (manufactured by Ohkawara Kakoki Co., Ltd.), at a rotation speed of 25,000 rpm, at hot air temperature of 150° C., and at temperature of a particle recovery exit of 90° C. to obtain composite particles. A volume average particle diameter of these composite particles was 40 μm.

(Manufacturing Negative Electrode for Lithium Ion Secondary Battery)

Subsequently, the resulting particles were supplied to a roll of a roll press machine (press-cutting rough surface heat roll, manufactured by Hirano Giken Kogyo Co., Ltd.) (roll temperature: 100° C. , press linear pressure: 4.0 kN/cm), and were molded into a sheet at a molding speed of 20 m/minute to obtain a negative electrode for a lithium ion secondary battery having a thickness of 80 μm.

(Manufacturing Slurry for Positive Electrode and Positive Electrode for Lithium Ion Secondary Battery)

Polyvinylidene fluoride (PVDF; “KF-1100” manufactured by Kureha Corporation) as a binder resin for a positive electrode was added to 92 parts of LiCoO₂ (sometimes abbreviated as “LCO”) as a positive electrode active material, such that the solid content thereof became 2 parts. Furthermore, 6 parts of acetylene black (AB; “HS-100” manufactured by Denki Kagaku Kogyo Kabushiki Kaisha) and 20 parts of N-methylpyrrolidone were added thereto, and mixed with a planetary mixer to obtain a slurry for a positive electrode. This slurry for a positive electrode was applied on an aluminum foil having a thickness of 18 μm, dried at 120° C. for 30 minutes, and then roll-pressed to obtain a positive electrode for a lithium ion secondary battery having a thickness of 60 μm.

(Preparation of Separator)

A separator having a single layer made of polypropylene (width: 65 mm, length: 500 mm, thickness: 25 μm, manufactured by a dry method, porosity: 55%) was cut out into a square of 5×5 cm².

(Manufacturing Lithium Ion Secondary Battery)

As an exterior of a battery, an aluminum packaging material exterior was prepared. The positive electrode for a lithium ion secondary battery obtained above was cut out into a square of 4×4 cm², and disposed such that a surface on a side of the current collector came into contact with the aluminum packaging material exterior. The square separator obtained above was disposed on a surface of the positive electrode active material layer of the positive electrode for a lithium ion secondary battery. Furthermore, the negative electrode for a lithium ion secondary battery obtained above was cut into a square of 4.2×4.2 cm², and disposed on the separator such that a surface on a side of the negative electrode active material layer faced the separator. In addition, a LiPF₆ solution containing 2.0% of vinylene carbonate and having a concentration of 1.0 M was poured thereinto. A solvent in this LiPF₆ solution is a mixed solvent of ethylene carbonate (EC) and ethyl methyl carbonate (EMC) (EC/EMC=3/7 (volume ratio)). Furthermore, in order to seal the opening of the aluminum packaging material, the aluminum exterior was closed by heat sealing at 150° C. to manufacture a laminate-type lithium ion secondary battery (laminate-type cell).

### Example 2

The manufacture of a slurry for composite particles, the manufacture of composite particles, the manufacture of a negative electrode for a lithium ion secondary battery, and the manufacture of the lithium ion secondary battery were performed in the same manner as in Example 1 except that 90 parts of artificial graphite and 6.5 parts of SiC were used in combination as a negative electrode active material.

### Example 3

The manufacture of a slurry for composite particles, the manufacture of composite particles, the manufacture of a negative electrode for a lithium ion secondary battery, and the manufacture of the lithium ion secondary battery were performed in the same manner as in Example 1 except that a 2% aqueous dispersion of chitin nanofibers (BiNFi-s(SFo-10002), fiber diameter: 20 nm, polymerization degree: 300; manufactured by Sugino Machine Limited) was used as water-insoluble polysaccharide polymer fibers.

### Example 4

The manufacture of a slurry for composite particles, the manufacture of composite particles, the manufacture of a negative electrode for a lithium ion secondary battery, and the manufacture of the lithium ion secondary battery were performed in the same manner as in Example 1 except that a 2% aqueous dispersion of chitosan nanofibers (BiNFi-s(EFo-10002), fiber diameter: 20 nm, polymerization degree: 480; manufactured by Sugino Machine Limited) was used as water-insoluble polysaccharide polymer fibers.

### Example 5

(Manufacturing Cellulose Nanofibers)

Pulp was added to ion-exchanged water so as to be 1% by weight, and stirred for one hour with a juicer to obtain an aqueous dispersion of pulp. Using an emulsifying and dispersing apparatus (Milder MDN303V; manufactured by Pacific Machinery & Engineering Co., Ltd.), 1 kg of the aqueous dispersion of pulp was stirred for three hours at 15000 rpm to manufacture cellulose nanofibers B having an average fiber diameter of 100 nm. These cellulose nanofibers B had a fiber diameter of 100 nm and a polymerization degree of 600.

The manufacture of a slurry for composite particles, the manufacture of composite particles, the manufacture of a negative electrode for a lithium ion secondary battery, and the manufacture of the lithium ion secondary battery were performed in the same manner as in Example 1 except that the cellulose nanofibers B were used as the cellulose water-insoluble polysaccharide polymer fibers.

### Example 6

Cellulose nanofibers C were obtained by manufacturing cellulose nanofibers in the same manner as in Example 5 except that the stirring time in the emulsifying and dispersing apparatus was 30 minutes. These cellulose nanofibers C had a fiber diameter of 1000 nm and a polymerization degree of 800.

The manufacture of a slurry for composite particles, the manufacture of composite particles, the manufacture of a negative electrode for a lithium ion secondary battery, and the manufacture of the lithium ion secondary battery were performed in the same manner as in Example 1 except that the cellulose nanofibers C were used as the cellulose water-insoluble polysaccharide polymer fibers.

### Example

Cellulose nanofibers D were obtained by manufacturing cellulose nanofibers in the same manner as in Example 5 except that the stirring time in the emulsifying and dispersing apparatus was 20 minutes. These cellulose nanofibers D had a fiber diameter of 2000 nm and a polymerization degree of 1000.

The manufacture of a slurry for composite particles, the manufacture of composite particles, the manufacture of a negative electrode for a lithium ion secondary battery, and the manufacture of the lithium ion secondary battery were performed in the same manner as in Example 1 except that the cellulose nanofibers D were used as the cellulose water-insoluble polysaccharide polymer fibers.

### Example 8

The manufacture of a slurry for composite particles, the manufacture of composite particles, the manufacture of a negative electrode for a lithium ion secondary battery, and the manufacture of the lithium ion secondary battery were performed in the same manner as in Example 1 except that the amount of negative electrode active material was 97.5 parts of artificial graphite and the amount of the cellulose nanofibers A was 1 part in terms of solid content.

### Example 9

The manufacture of a slurry for composite particles, the manufacture of composite particles, the manufacture of a negative electrode for a lithium ion secondary battery, and the manufacture of the lithium ion secondary battery were performed in the same manner as in Example 1 except that the amount of a negative electrode active material was 95.7 parts of artificial graphite, the amount of the cellulose nanofibers A was 3 parts in terms of solid content, and the amount of CMC was 0.1 parts in terms of solid content.

### Comparative Example 1

The manufacture of a slurry for composite particles, the manufacture of composite particles, the manufacture of a negative electrode for a lithium ion secondary battery, and the manufacture of the lithium ion secondary battery were performed in the same manner as in Example 1 except that the cellulose nanofibers A as a water-insoluble polysaccharide polymer were not added, the amount of a negative electrode active material was 98.1 parts of artificial graphite, and the amount of CMC was 0.7 parts in terms of solid content.

### Comparative Example 2

The manufacture of a slurry for composite particles, the manufacture of composite particles, the manufacture of a negative electrode for a lithium ion secondary battery, and the manufacture of the lithium ion secondary battery were performed in the same manner as in Example 1 except that carbon nanofibers were used as reinforcing fibers (VGCF: manufactured by Showa Denko K.K., fiber diameter: 150 nm, fiber length: 20 μm) in place of the water-insoluble polysaccharide polymer fibers and the amount of CMC was 0.7 parts in terms of solid content.

### Comparative Example 3

The manufacture of a slurry for composite particles and the manufacture of composite particles were performed in the same manner as in Example 1 except that the CMC as a water-soluble polymer was not added, the amount of a negative electrode active material was 96.8 parts of artificial graphite, and the amount of the cellulose nanofibers A was 2 parts in terms of solid content. However, it was difficult to manufacture a negative electrode for a lithium ion secondary battery. Therefore, it was not possible to manufacture a lithium ion secondary battery.

TABLE 1

| Item | | | Ex. 1 | Ex. 2 | Ex. 3 | Ex. 4 |
|---|---|---|---|---|---|---|
| Negative | Negative electrode | Type | Artificial | Artificial | Artificial | Artificial |
| electrode for | active material | | graphite | graphite + SiC | graphite | graphite |
| lithium ion | | Amount (part) | 96.5 | 90 + 6.5 | 96.5 | 96.5 |
| secondary | Binder resin | Type | SBR | SBR | SBR | SBR |
| battery | | Amount (part) | 1.2 | 1.2 | 1.2 | 1.2 |
| | Water-insoluble | Type | Cellulose | Cellulose | Chitin | Chitosan |
| | polysaccharide | | nanofibers A | nancfibers A | nanofibers | nanofibers |
| | polymer fibers | Fiber diameter (nm) | 20 | 20 | 20 | 20 |
| | | Amount (part) | 2 | 2 | 2 | 2 |
| | | Polymerization degree | 500 | 500 | 300 | 480 |
| | Reinforcing fibers | Type | — | — | — | — |
| | | Fiber diameter (nm) | — | — | — | — |
| | | Amount (part) | — | — | — | — |
| | Water-soluble | Type | CMC | CMC | CMC | CMC |
| | polymer | Amount (part) | 0.3 | 0.3 | 0.3 | 0.3 |
| Positive | Positive electrode | Type | LCO | LCO | LCO | LCO |
| electrode for | active material | Amount (part) | 92 | 92 | 92 | 92 |
| lithium ion | Electroconductive | Type | AB | AB | AB | AB |
| secondary | auxiliary agent | Amount (part) | 6 | 6 | 6 | 6 |
| battery | Binder resin for | Type | PVDF | PVDF | PVDF | PVDF |
| | positive electrode | Amount (part) | 2 | 2 | 2 | 2 |

| | | | | | |
|---|---|---|---|---|---|
| Evaluation | Particle strength of | A | A | B | B |
| | composite particles | | | | |
| | Peel strength | A | A | A | A |
| | Charge-discharge cycle | A | B | A | A |
| | characteristics | | | | |

| Item | | | Ex. 5 | Ex. 6 | Ex. 7 | Ex. 8 |
|---|---|---|---|---|---|---|
| Negative | Negative electrode | Type | Artificial | Artificial | Artificial | Artificial |
| electrode for | active material | | graphite | graphite | graphite | graphite |
| lithium ion | | Amount (part) | 96.5 | 96.5 | 96.5 | 97.5 |
| secondary | Binder resin | Type | SBR | SBR | SBR | SBR |
| battery | | Amount (part) | 1.2 | 1.2 | 1.2 | 1.2 |
| | Water-insoluble | Type | Cellulose | Cellulose | Cellulose | Cellulose |
| | polysaccharide | | nanofibers B | nanofibers C | nanofibers D | nanofibers A |
| | polymer fibers | Fiber diameter (nm) | 100 | 1000 | 2000 | 20 |
| | | Amount (part) | 2 | 2 | 2 | 1 |
| | | Polymerization degree | 600 | 800 | 1000 | 500 |
| | Reinforcing fibers | Type | — | — | — | — |
| | | Fiber diameter (nm) | — | — | — | — |
| | | Amount (part) | — | — | — | — |
| | Water-soluble | Type | CMC | CMC | CMC | CMC |
| | polymer | Amount (part) | 0.3 | 0.3 | 0.3 | 0.3 |
| Positive | Positive electrode | Type | LCO | LCO | LCO | LCO |
| electrode for | active material | Amount (part) | 92 | 92 | 92 | 92 |
| lithium ion | Electroconductive | Type | AB | AB | AB | AB |
| secondary | auxiliary agent | Amount (part) | 6 | 6 | 6 | 6 |
| battery | Binder resin for | Type | PVDF | PVDF | PVDF | PVDF |
| | positive electrode | Amount (part) | 2 | 2 | 2 | 2 |
| Evaluation | | Particle strength of | A | B | B | B |
| | | composite particles | | | | |
| | | Peel strength | A | B | B | B |
| | | Charge-discharge cycle | B | B | C | A |
| | | characteristics | | | | |
| Item | | | Ex. 9 | Comp. Ex. 1 | Comp. Ex. 2 | Comp. Ex. 3 |
| Negative | Negative electrode | Type | Artificial | Artificial | Artificial | Artificial |
| electrode for | active material | | graphite | graphite | graphite | graphite |
| lithium ion | | Amount (part) | 95.7 | 98.1 | 96.5 | 96.8 |
| secondary | Binder resin | Type | SBR | SBR | SBR | SBR |
| battery | | Amount (part) | 1.2 | 1.2 | 1.2 | 1.2 |
| | Water-insoluble | Type | Cellulose | — | — | Cellulose |
| | polysaccharide | | nanofibers A | | | nanofibers A |
| | polymer fibers | Fiber diameter (nm) | 20 | — | — | 20 |
| | | Amount (part) | 3 | — | — | 2 |
| | | Polymerization degree | 500 | — | — | 500 |
| | Reinforcing fibers | Type | — | — | VGCF | — |
| | | Fiber diameter (nm) | — | — | 150 | — |
| | | Amount (part) | — | — | 2 | — |
| | Water-soluble | Type | CMC | CMC | CMC | — |
| | polymer | Amount (part) | 0.1 | 0.7 | 0.7 | — |
| Positive | Positive electrode | Type | LCO | LCO | LCO | LCO |
| electrode for | active material | Amount (part) | 92 | 92 | 92 | 92 |
| lithium ion | Electroconductive | Type | AB | AB | AB | AB |
| secondary | auxiliary agent | Amount (part) | 6 | 6 | 6 | 6 |
| battery | Binder resin for | Type | PVDF | PVDF | PVDF | PVDF |
| | positive electrode | Amount (part) | 2 | 2 | 2 | 2 |

| | | | | | |
|---|---|---|---|---|---|
| Evaluation | Particle strength of | A | E | E | D |
| | composite particles | | | | |
| | Peel strength | A | D | C | E |
| | Charge-discharge cycle | C | D | D | E |
| | characteristics | | | | |

As illustrated in Table 1, the composite particles including the negative electrode active material, the binder resin, the water-soluble polymer, and the water-insoluble polysaccharide polymer fibers had excellent particle strength. The negative electrode for a lithium ion secondary battery obtained using these composite particles had excellent peel strength. In addition, the lithium ion secondary battery manufactured using this negative electrode for a lithium ion secondary battery had excellent charge-discharge cycle characteristics.

1. Composite particles for an electrochemical device electrode comprising:
a negative electrode active material;
a binder resin;
a water-soluble polymer; and
water-insoluble polysaccharide polymer fibers.

2. The composite particles for an electrochemical device electrode according to claim 1, wherein
the water-insoluble polysaccharide polymer has a fiber diameter of 5 to 3000 nm.

3. The composite particles for an electrochemical device electrode according to claim 1, wherein
100 parts by weight of the composite particles for an electrochemical device include 0.2 to 4 parts by weight of the water-insoluble polysaccharide polymer fibers.

4. The composite particles for an electrochemical device electrode according to claim 1, wherein
the binder resin is particulate.

5. A method for manufacturing composite particles for an electrochemical device electrode to obtain the composite particles for an electrochemical device electrode according to claim 1, comprising:
a step of obtaining a slurry for composite particles by dispersing the negative electrode active material, the binder resin, the water-soluble polymer, and the water-insoluble polysaccharide polymer fibers in a solvent; and
a step of granulating by spray drying the slurry for composite particles.

6. An electrochemical device electrode obtained by laminating an electrode active material layer including the composite particles for an electrochemical device electrode according to claim 1 on a current collector.

7. The electrochemical device electrode according to claim 6, wherein the electrode active material layer is obtained by pressure-molding an electrode material including the composite particles for an electrochemical device electrode on the current collector.

8. An electrochemical device comprising the electrochemical device electrode according to claim 6.
